(19) United States
(12) Patent Application Publication
(10) Pub. No.: US 2020/0368832 A1
(43) Pub. Date: Nov. 26, 2020

(54) Miter Saw Table Apparatus

(71) Applicant: Harold Barringer, Decatur, IL (US)

(72) Inventor: Harold Barringer, Decatur, IL (US)

(21) Appl. No.: 16/419,720

(22) Filed: May 22, 2019

(51) Int. Cl. B23D 47/02; B25H 1/06

(52) U.S. Cl. CPC B23D 47/025; B25H 1/06

(57) ABSTRACT

A miter saw table apparatus for providing an ideal work table for a miter saw includes a table body. A top side of the table body has a saw depression that is configured to receive a miter saw such that the top side supports lumber on either side of the miter saw. The table body has a cord aperture extending through to the table inside. A bottom side of the table body is configured to rest on a pair of saw horses. At least one outlet panel is coupled to the table body and comprises a mounting plate and a plurality of outlets. A power cord is coupled to the outlet panel. The power cord is in operational communication with the plurality of outlets and extends through the cord aperture to be plugged into a wall outlet.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to work tables and more particularly pertains to a new work table for providing an ideal work table for a miter saw.

### BRIEF SUMMARY OF THE INVENTION

An embodiment of the disclosure meets the needs presented above by generally comprising a table body that has a bottom side separated from a top side, a right side separated from a left side, and a front side separated from a back side defining a table inside. The top side has a saw depression extending towards the bottom side and extending from the front side to the back side. The saw depression is configured to receive a miter saw. The table body has a cord aperture extending through to the table inside. The bottom side is configured to rest on a pair of saw horses. At least one outlet panel is coupled to the table body. The outlet panel comprises a mounting plate and a plurality of outlets. The outlet panel is coupled within the mounting plate and extends through the front side into the table inside. A power cord is coupled to the outlet panel. The power cord is in operational communication with the plurality of outlets and extends through the cord aperture.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a miter saw table apparatus according to an embodiment of the disclosure.

FIG. 2 is a top plan view of an embodiment of the disclosure.

FIG. 3 is a bottom plan view of an embodiment of the disclosure.

FIG. 4 is a front elevation view of an embodiment of the disclosure.

FIG. 5 is an in-use view of an embodiment of the disclosure.

### DETAILED DESCRIPTION OF THE INVENTION

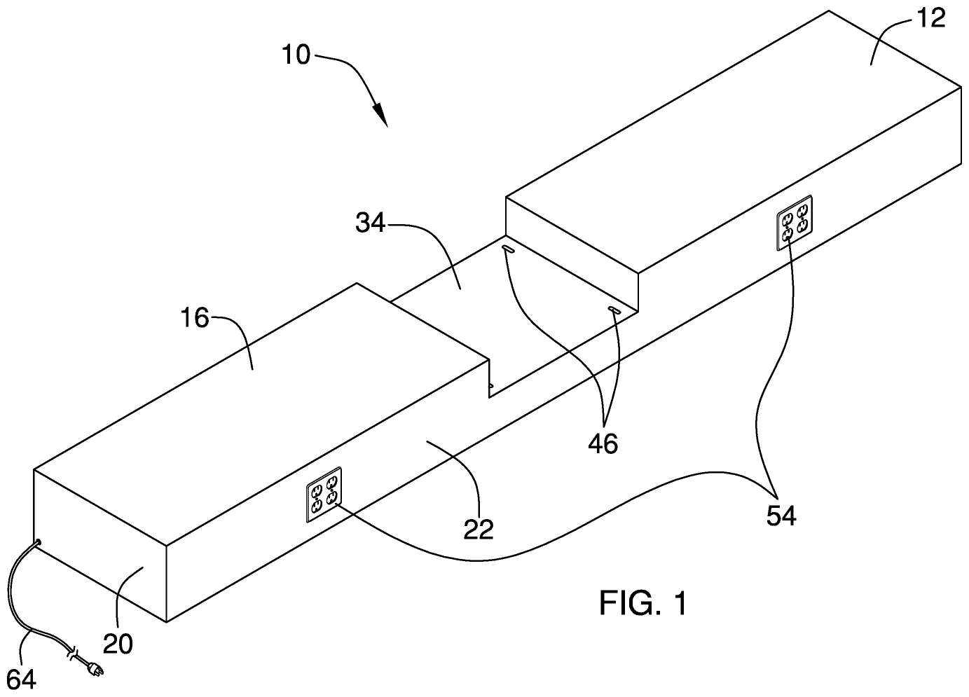

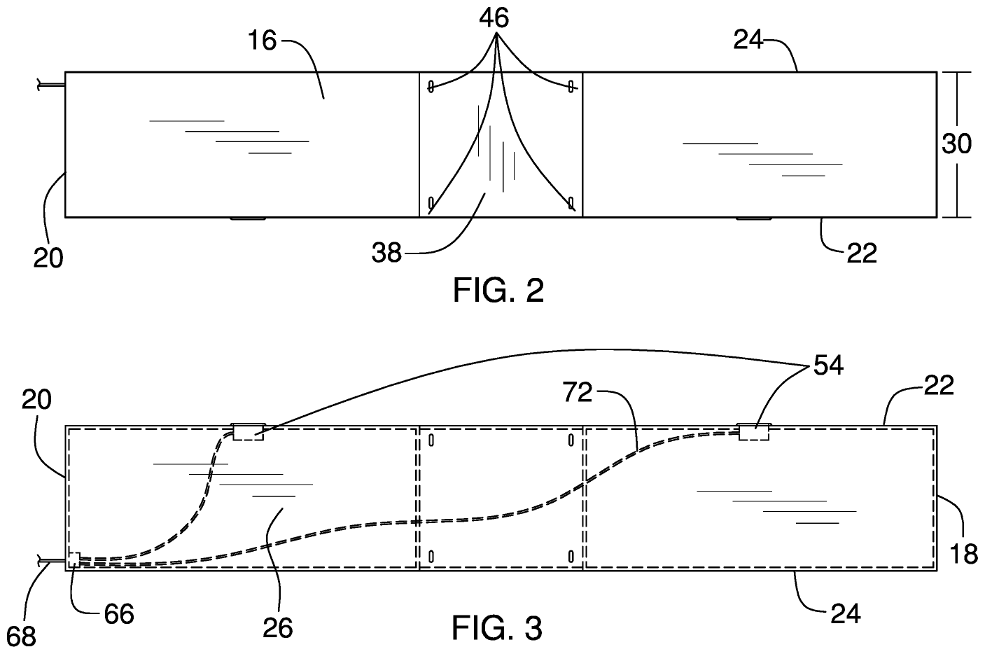

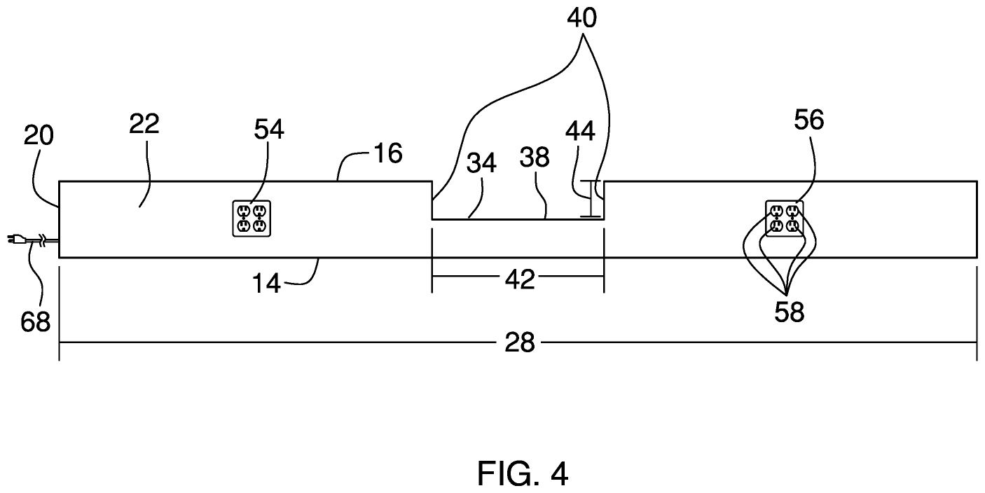

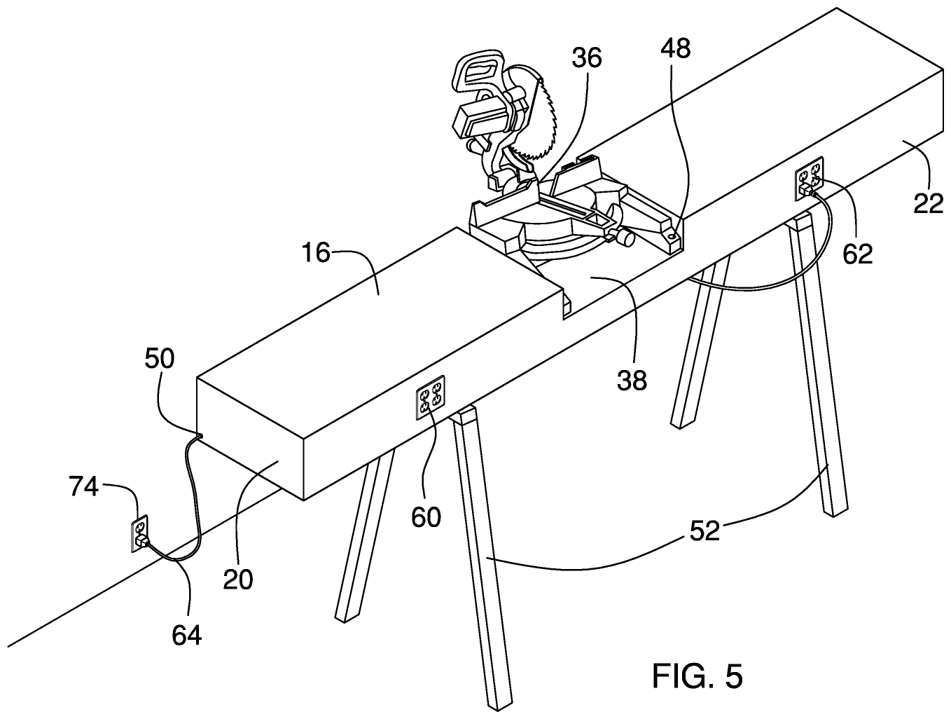

With reference now to the drawings, and in particular to FIGS. 1 through 5 thereof, a new work table embodying the principles and concepts of an embodiment of the disclosure and generally designated by the reference numeral 10 will be described.

As best illustrated in FIGS. 1 through 5, the miter saw table apparatus 10 generally comprises a table body 12 having a bottom side 14 separated from a top side 16, a right side 18 separated from a left side 20, and a front side 22 separated from a back side 24 defining a table inside 26. The table body 12 has a table width 28 between the left side 20 and the right side 18 equal to six times a table depth 30 between the front side 22 and the back side 24. The table body 12 has a table height 32 between the top side 16 and the bottom side 14 equal to one half the table depth 30. The top side 16 has a saw depression 34 extending towards the bottom side 14 and extending from the front side 22 to the back side 24. The saw depression 34 is configured to receive a miter saw 36 and may be rectangular. The saw depression 34 has a bottom wall 38 and a pair of side walls 40. The saw depression 34 has a depression width 42 between the pair of side walls 40 equal to at least four times a depression height 44 between the bottom wall 38 and the top side 16 of the table body 12. The depression width 42 is greater than the table depth 30, and the depression height 44 is equal to one half the table height 32. The table width 28 is 96 inches, the table depth 30 is 16 inches, and table height 32 is 8 inches. The depression width 42 is 18 inches and the depression height 44 is 4 inches. These dimensions are ideal for standard lumber lengths during home construction. The depression height 44 accommodates the miter saw 36 such that lumber is supported by the top side 16 of the table body on either side of the miter saw 36.

The bottom wall 38 has a set of four mounting holes 46 configured to receive a plurality of fasteners 48 to fix the miter saw 36 in place. The table body 12 has a cord aperture 50 extending through the left side 20 to the table inside 26 adjacent the bottom side 14 and the back side 24. The bottom side 14 is configured to rest on a pair of saw horses 52. At least one outlet panel 54 is coupled to the table body 12, and the outlet panel 54 comprises a mounting plate 56 and a plurality of outlets 58. The plurality of outlets 58 may be a set of four outlets 58 arranged in a square pattern. The plurality of outlets 58 provides power for the miter saw 36 and for other power tools. The outlet panel 54 is coupled within the mounting plate 56 and extends through the front side 22 into the table inside 26. The at least one outlet panel 54 may be a pair of outlet panels 54 comprising a left outlet panel 60 coupled between the saw depression 34 and the left side 20 and a right outlet panel 62 coupled between the saw depression 34 and the right side 18. A power cord 64 is coupled to the outlet panel 54. The power cord 64 comprises a splitter 66 coupled within the table inside 26 adjacent the cord aperture 50. A main cord 68 is coupled to the splitter 66 and extends through the cord aperture 50. A first extension cord 70 is coupled to the splitter 66 and to the left outlet panel 60, and a second extension cord 72 is coupled to the splitter 66 and to the right outlet panel 62. The power cord 64 is in operational communication with the plurality of outlets 58.

In use, the user places the miter saw 36 in the saw depression 34 and connects it to one of the plurality of outlets 58. The main cord 68 is plugged into a wall outlet 74. and the miter saw 36 may then be used normally with the top side 16 securing wood on either side of the miter saw 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A miter saw table apparatus comprising:
a table body, the table body having a bottom side separated from a top side, a right side separated from a left side, and a front side separated from a back side defining a table inside, the top side having a saw depression extending towards the bottom side and extending from the front side to the back side, the saw depression being configured to receive a miter saw, the table body having a cord aperture extending through to the table inside, the bottom side being configured to rest on a pair of saw horses;
at least one outlet panel coupled to the table body, the outlet panel comprising a mounting plate and a plurality of outlets, the outlet panel being coupled within the mounting plate and extending through the front side into the table inside; and
a power cord coupled to the outlet panel, the power cord being in operational communication with the plurality of outlets and extending through the cord aperture.

2. The miter saw table apparatus of claim 1 further comprising the saw depression being rectangular and having a bottom wall and a pair of side walls, the bottom wall having a set of four mounting holes configured to receive a plurality of fasteners to fix the miter saw in place.

3. The miter saw table apparatus of claim 1 further comprising the plurality of outlets being a set of four outlets arranged in a square pattern.

4. The miter saw table apparatus of claim 1 further comprising the at least one outlet panel being a pair of outlet panels comprising a left outlet panel coupled between the saw depression and the left side and a right outlet panel coupled between the saw depression and the right side, the power cord comprising a splitter coupled within the table inside adjacent the cord aperture, a main cord coupled to the splitter and extending through the cord aperture, a first extension cord coupled to the splitter and to the left outlet panel, and a second extension cord coupled to the splitter and to the right outlet panel.

5. The miter saw table apparatus of claim 1 further comprising the cord aperture extending through the left side adjacent the bottom side and the back side.

6. The miter saw table apparatus of claim 1 further comprising the table body having a table width between the left side and the right side equal to six times a table depth between the front side and the back side.

7. The miter saw table apparatus of claim 6 further comprising the table body having a table height between the top side and the bottom side equal to one half the table depth.

8. The miter saw table apparatus of claim 2 further comprising the saw depression having a depression width between the pair of side walls equal to at least four times a depression height between the bottom wall and the top side of the table body.

9. The miter saw table apparatus of claim 8 further comprising the depression width being greater than a table depth between the front side and the back side.

10. The miter saw table apparatus of claim 8 further comprising the depression height being equal to one half a table height between the top side and the bottom side.

11. A miter saw table apparatus comprising:
a table body, the table body having a bottom side separated from a top side, a right side separated from a left side, and a front side separated from a back side defining a table inside, the table body having a table width between the left side and the right side equal to six times a table depth between the front side and the back side, the table body having a table height between the top side and the bottom side equal to one half the table depth, the top side having a saw depression extending towards the bottom side and extending from the front side to the back side, the saw depression being configured to receive a miter saw, the saw depression being rectangular and having a bottom wall and a pair of side walls, the saw depression having a depression width between the pair of side walls equal to at least four times a depression height between the bottom wall and the top side of the table body, the depression width being greater than the table depth, the depression height being equal to one half the table height, the bottom wall having a set of four mounting holes configured to receive a plurality of fasteners to fix the miter saw in place, the table body having a cord aperture extending through the left side to the table inside adjacent the bottom side and the back side, the bottom side being configured to rest on a pair of saw horses;
at least one outlet panel coupled to the table body, the outlet panel comprising a mounting plate and a plurality of outlets, the plurality of outlets being a set of four outlets arranged in a square pattern, the outlet panel being coupled within the mounting plate and extending through the front side into the table inside, the at least one outlet panel being a pair of outlet panels comprising a left outlet panel coupled between the saw depression and the left side and a right outlet panel coupled between the saw depression and the right side; and
a power cord coupled to the outlet panel, the power cord comprising a splitter coupled within the table inside adjacent the cord aperture, a main cord coupled to the splitter and extending through the cord aperture, a first extension cord coupled to the splitter and to the left outlet panel, and a second extension cord coupled to the splitter and to the right outlet panel, the power cord being in operational communication with the plurality of outlets.

12. A saw horse and miter saw table apparatus combination comprising:
a pair of saw horses;
a table body, the table body having a bottom side separated from a top side, a right side separated from a left side, and a front side separated from a back side defining a table inside, the table body having a table width between the left side and the right side equal to six times a table depth between the front side and the back side, the table body having a table height between the top side and the bottom side equal to one half the table depth, the top side having a saw depression extending towards the bottom side and extending from the front side to the back side, the saw depression being configured to receive a miter saw, the saw depression being rectangular and having a bottom wall and a pair of side walls, the saw depression having a depression width between the pair of side walls equal to at least four times a depression height between the bottom wall and the top side of the table body, the depression width being greater than the table depth, the depression height being equal to one half the table height, the bottom wall having a set of four mounting holes configured to receive a plurality of fasteners to fix the miter saw in place, the table body having a cord aperture extending through the left side to the table inside adjacent the bottom side and the back side, the bottom side being configured to rest on the pair of saw horses;
at least one outlet panel coupled to the table body, the outlet panel comprising a mounting plate and a plurality of outlets, the plurality of outlets being a set of four outlets arranged in a square pattern, the outlet panel being coupled within the mounting plate and extending through the front side into the table inside, the at least one outlet panel being a pair of outlet panels comprising a left outlet panel coupled between the saw depression and the left side and a right outlet panel coupled between the saw depression and the right side; and
a power cord coupled to the outlet panel, the power cord comprising a splitter coupled within the table inside adjacent the cord aperture, a main cord coupled to the splitter and extending through the cord aperture, a first extension cord coupled to the splitter and to the left outlet panel, and a second extension cord coupled to the splitter and to the right outlet panel, the power cord being in operational communication with the plurality of outlets.
